(19) United States
(12) Patent Application Publication
(10) Pub. No.: US 2016/0338381 A1
(43) Pub. Date: Nov. 24, 2016

(54) DRY AND MOIST PIECE CHEESEBURGER PET FOOD

(71) Applicant: Wal-Mart Stores, Inc., Bentonville, AR (US)

(72) Inventors: Jamie Russell Perez, Siloam Springs, AR (US); Timothy John Dodge, Bentonville, AR (US)

(21) Appl. No.: 15/143,923

(22) Filed: May 2, 2016

Related U.S. Application Data
(60) Provisional application No. 62/165,451, filed on May 22, 2015.

(51) Int. Cl. A23K 40/00; A23K 10/20; A23K 10/30; A23K 50/40

(52) U.S. Cl. CPC A23K 40/00; A23K 50/40; A23K 10/20; A23K 10/30

(57) ABSTRACT

Provided is a dry and moist pieces cheeseburger pet food that mimics human food. The cheeseburger pet food includes a plurality of bun pieces, wherein the bun pieces are dry pet food shaped like hamburger buns. The pet food also includes a plurality of burger pieces, wherein the burger pieces are dry pet food shaped like hamburger patties. The pet food also includes a plurality of cheese pieces, wherein the cheese pieces are soft moist pet food shaped like cheese slices. The plurality of bun pieces and the plurality of burger pieces include a cheeseburger flavor and the plurality of cheese pieces are made with real cheese. Further, the bun pieces, burger pieces and cheese pieces are provided in a ratio of total product weight to mimic the ratio of similar pieces of a human cheeseburger.

### RELATED APPLICATION

This application claims priority to U.S. Provisional Patent Application Ser. No. 62/165,451 to Wal-Mart Stores Inc., filed May 22, 2015 and entitled “Dry and Moist Piece Cheeseburger Pet Food”, which is hereby incorporated entirely herein by reference.

### FIELD OF THE INVENTION

The invention relates generally to pet food, and more specifically, to dry and moist piece pet food that mimics human food.

### BACKGROUND

Currently there does not exist in the market today cheeseburger pet food that includes dry pet food with a soft moist piece. The current market further does not have a piece ratio that mimics a cheeseburger in appearance. As pet are becoming considered more a part of human families, there is an additional need in the market to have more humanized pet foods. The need includes having a dry pet food that mimics human food, and further, the market and/or category needs to have the same visual components as that of human food.

### BRIEF SUMMARY

In one aspect, provided is a dry piece and soft moist piece cheeseburger pet food comprising: a plurality of bun pieces, wherein the bun pieces are dry pet food shaped like hamburger buns; a plurality of burger pieces, wherein the burger pieces are dry pet food shaped like hamburger patties; and a plurality of cheese pieces, wherein the cheese pieces are soft moist pet food shaped like cheese slices, wherein the plurality of bun pieces and the plurality of burger pieces include a cheeseburger flavor and the plurality of cheese pieces are made with real cheese.

In another aspect, provided is a dry piece and soft moist piece cheeseburger dog food comprising: a plurality of bun pieces, wherein the bun pieces are dry pet food shaped like hamburger buns; a plurality of burger pieces, wherein the burger pieces are dry pet food shaped like hamburger patties; and a plurality of cheese pieces, wherein the cheese pieces are soft moist pet food shaped like cheese slices, wherein the plurality of bun pieces and the plurality of burger pieces include a cheeseburger flavor and the plurality of cheese pieces are made with real cheese.

In another aspect, provided is a method for purchasing store items, comprising: receiving at an input device unique customer identification information from a purchaser card; verifying the received unique customer identification information; associating purchase data with the unique customer identification information of the purchaser card; and updating the customer record to include the purchase data.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a perspective view of a pet food that mimics a cheeseburger, in accordance with embodiments of the present invention.

FIG. 2 is an exploded view of the pet food of FIG. 1, in accordance with some embodiments.

FIG. 3 is a diagram illustrating a cheeseburger ratio of cheese pieces to bun and burger pieces, in accordance with some embodiments.

FIG. 4 is a diagram illustrating a bun/burger ratio of bun pieces to burger pieces, in accordance with some embodiments.

### DETAILED DESCRIPTION

Many people own pets. These pets, particularly cats and dogs, are becoming part of the family and many pet owners seek to humanize the pets. One form of evidence of such this humanization of animals includes clothes, styled collars, hats, glasses, costumes, jerseys, socks and all types of accessories are frequently purchased by pet owners to have their pets wear such clothes and accessories. Photos are taken and uploaded on social media of pets and stories told of actions and happening of the pets similar to stories of parents with regard to their children. Medical care is provided and pets are taken on trips and vacations. Pets are essentially another member of the family for many pet owners. This is even more true with dogs.

Because of this humanization of pets, it is natural for pet owners to seek feeding the pet with human food. However, human food is often bad for a pet's health. Accordingly, pet owners have a need for more humanized pet foods. Again, this is more prevalent with dog owners over other pets.

The present inventive concepts provide for humanization of pet food. This humanization of pet food includes humanizing the type of food. Further, the humanization of pet food in accordance with embodiments of the present invention includes mimicking human food. Particularly, in some embodiments, the humanization of pet food includes production of a pet food that mimics a cheeseburger in food and in appearance.

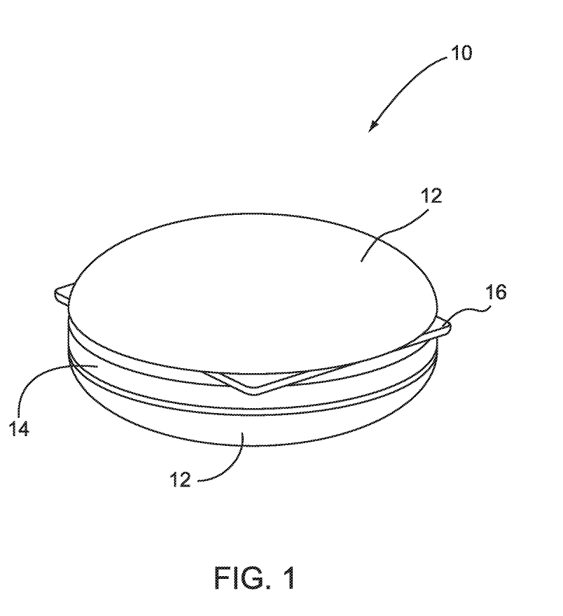

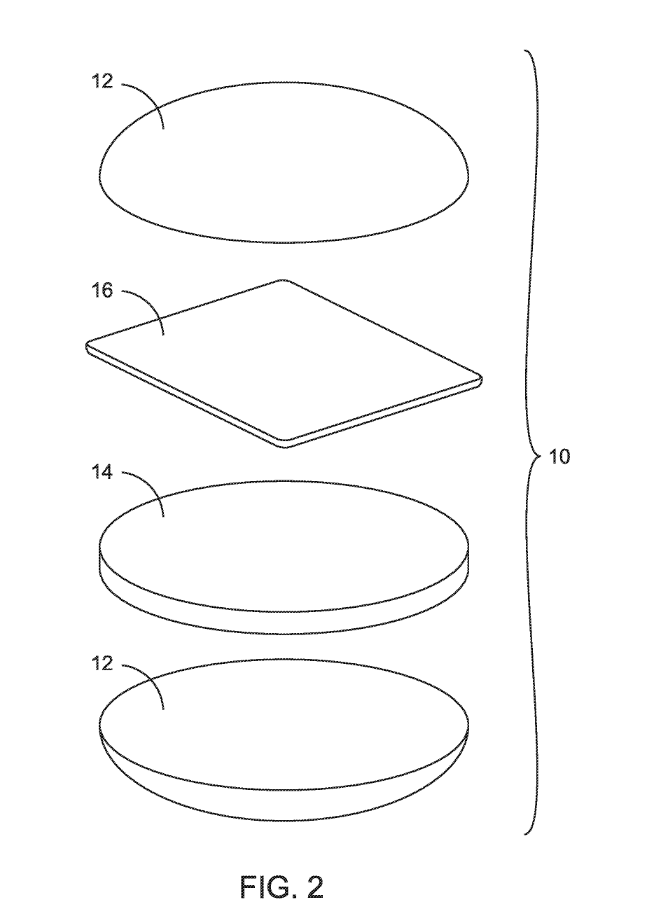

FIG. 1 is a perspective view and FIG. 2 is a perspective exploded view of a cheeseburger pet food 10. The cheeseburger pet food 10 may comprise a plurality of bun pieces 12, a plurality of burger pieces 14 and a plurality of cheese pieces 16. As can be seen in FIGS. 1 and 2, the bun pieces 12 resemble and mimic a bun of a human cheeseburger; the burger pieces 14 resemble and mimic a burger patty of a human cheeseburger, and the cheese pieces 16.

In some embodiments, the bun pieces 12 may be shaped in a same shape as shown in FIGS. 1 and 2, wherein there is a flat side 11 and a rounded side 13. However, in some embodiments, the bun pieces 12 may be shaped as other types of hamburger buns, mimicking the variety of buns that humans use on their burgers. The bun pieces 12 may also mimic human hamburger buns in color. The bun pieces 12, in accordance with embodiments of the present invention may be formed from dry pet food. This bun piece 12 dry pet food may be manufactured in a manner similar to other kibble or dry pet food.

In some embodiments, the burger pieces 14 may be shaped as shown in FIGS. 1 and 2, wherein there are two flat sides 15, similar to a human hamburger patty. However, in some embodiments, the burger pieces 14 may be shaped as other types of hamburger patties, mimicking the variety of patties that humans use on their burgers. The burger pieces 14 may also mimic human hamburger patties in color. The burger pieces 14, in accordance with embodiments of the present invention may be formed from dry pet food. This burger piece 14 dry pet food may be manufactured in a manner similar to other kibble or dry pet food.

In some embodiments, the bun pieces 12 and the burger pieces 14 may comprise cheeseburger flavor. In some embodiments, the bun pieces 12 and the burger pieces 14 may have the same cheeseburger flavor. In other embodiments, the bun pieces 12 may have a portion of the cheeseburger flavor, such as, but not limited to a flavor of a bun, and the burger pieces 14 may have another portion of the cheeseburger flavor, such as, but not limited to a flavor of the hamburger patty.

In some embodiments, the cheese pieces 16 may include a square shape, as depicted in FIGS. 1 and 2. However, in some embodiments, the cheese pieces 16 may be shaped as other types of cheese slices and the like, mimicking the variety of cheese slices and the like that humans use on their burgers. The cheese pieces 16 may also mimic human cheese slices in color. The cheese pieces 16, in accordance with embodiments of the present invention, may be formed from soft moist pet food. This cheese pieces 16 soft moist pet food may be manufactured in a manner similar to other soft moist pet food. Additionally, the cheese pieces 16 may be made with real cheese.

In order to further humanize the cheeseburger pet food 10, there needs to be an appropriate ratio of bun pieces 12, burger pieces 14 and cheese pieces 16. This is in consideration that humans typically view cheeseburgers as two bun halves with a single hamburger patty and a single slice of cheese. In embodiments, the cheeseburger pet food 10 will not be provided with each cheeseburger pet food 10 assembled as shown in FIG. 1, but rather, FIG. 1 was provide to depict how each of the pieces 12, 14 and 16 resemble and mimic a human cheeseburger. Embodiments will include a ratio that when a human sees the cheeseburger pet food 10, it will resemble a cheeseburger in a similar ratio as an assembled cheeseburger pet food 10 shown in FIG. 1. In at least these ways, the cheeseburger pet food looks like human food.

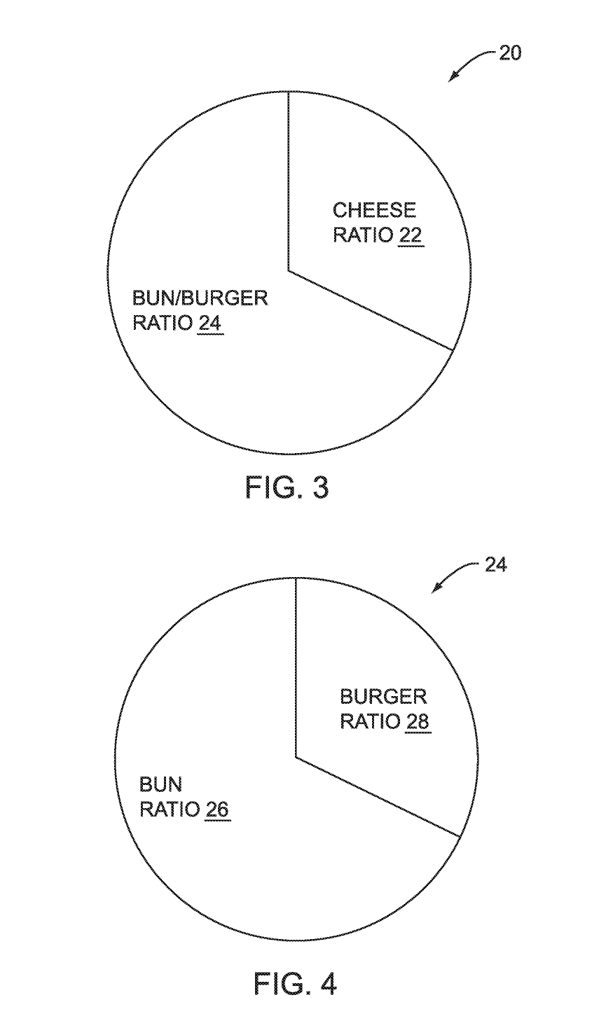

Referring to FIGS. 3 and 4, various ratios may be utilized in order to mimic a human cheeseburger in ratio. In some embodiments, the ratio may be based on total product weight, wherein the total product includes a plurality of bun pieces 12, a plurality of burger pieces 14, and a plurality of cheese pieces 16. In FIG. 3, a cheeseburger ration 20 refers to a cheese ratio 22 to a bun/burger ratio 24. Cheese ratio 22 refers to the ratio of cheese pieces 16; and bun/burger ratio 24 refers to the ratio of a combination of bun pieces 12 and burger pieces 14. In FIG. 4, bun ratio 26 refers to the ratio of bun pieces 12 of the bun/burger ratio 24; and burger ratio 28 refers to the ratio of burger pieces 14 of the bun/burger ratio 24. In some embodiments, the cheese ratio 22 may be 30-35% of total product weight and the bun/burger ratio may be 65-70% of total product weight. Of the bun/burger ratio 24, the bun ratio 26 may be 55-70% of total combined weight of bun pieces 12 and burger pieces 14 of the bun/burger ratio 24 and the burger ratio 28 may be 30-45% of total combined weight of bun pieces 12 and burger pieces 14 of the bun/burger ratio 24.

In some embodiments, the cheese ratio 22 may be 30-35% of total product weight and the bun/burger ratio may be 65-70% of total product weight. Of the bun/burger ratio 24, the bun ratio 26 may be 65-70% of total combined weight of bun pieces 12 and burger pieces 14 of the bun/burger ratio 24 and the burger ratio 28 may be 30-35% of total combined weight of bun pieces 12 and burger pieces 14 of the bun/burger ratio 24.

In some embodiments, the cheese ratio 22 may be 33-35% of total product weight and the bun/burger ratio may be 65-67% of total product weight. Of the bun/burger ratio 24, the bun ratio 26 may be 55-70% of total combined weight of bun pieces 12 and burger pieces 14 of the bun/burger ratio 24 and the burger ratio 28 may be 30-45% of total combined weight of bun pieces 12 and burger pieces 14 of the bun/burger ratio 24.

In some embodiments, the cheese ratio 22 may be 33-35% of total product weight and the bun/burger ratio may be 65-67% of total product weight. Of the bun/burger ratio 24, the bun ratio 26 may be 65-70% of total combined weight of bun pieces 12 and burger pieces 14 of the bun/burger ratio 24 and the burger ratio 28 may be 30-35% of total combined weight of bun pieces 12 and burger pieces 14 of the bun/burger ratio 24.

In some embodiments, the cheese ratio 22 may be approximately 35% of total product weight and the bun/burger ratio may be approximately 65% of total product weight. Of the bun/burger ratio 24, the bun ratio 26 may be approximately 67% of total combined weight of bun pieces 12 and burger pieces 14 of the bun/burger ratio 24 and the burger ratio 28 may be approximately 33% of total combined weight of bun pieces 12 and burger pieces 14 of the bun/burger ratio 24.

The ratio of dry pet food bun pieces 12 and dry pet food burger pieces 14 to soft moist cheese pieces 16 provides a ratio that when viewed by humans would appear the same ratio as a typical human cheeseburger. In at least this way the pet food mimics human food in ratio.

While the invention has been shown and described with reference to specific preferred embodiments, it should be understood by those skilled in the art that various changes in form and detail may be made therein without departing from the spirit and scope of the invention as defined by the following claims.

What is claimed is:

1. A dry piece and soft moist piece cheeseburger pet food comprising:
a plurality of bun pieces, wherein the bun pieces are dry pet food shaped like hamburger buns;
a plurality of burger pieces, wherein the burger pieces are dry pet food shaped like hamburger patties; and
a plurality of cheese pieces, wherein the cheese pieces are soft moist pet food shaped like cheese slices, wherein the plurality of bun pieces and the plurality of burger pieces include a cheeseburger flavor and the plurality of cheese pieces are made with real cheese.

2. The pet food of claim 1, further comprising a cheese ratio of 30-35% of total product weight and a bun/burger ratio of 65-70% of total product weight.

3. The pet food of claim 2, wherein the bun/burger ratio comprises a bun ratio of 55-70% of total combined weight of bun pieces and burger pieces of the bun/burger ratio and a burger ratio of 30-45% of total combined weight of bun pieces and burger pieces of the bun/burger ratio.

4. The pet food of claim 2, wherein the bun/burger ratio comprises a bun ratio of 65-70% of total combined weight of bun pieces and burger pieces of the bun/burger ratio and a burger ratio of 30-35% of total combined weight of bun pieces and burger pieces of the bun/burger ratio.

5. The pet food of claim 1, further comprising a cheese ratio of 33-35% of total product weight and a bun/burger ratio of 65-67% of total product weight.

6. The pet food of claim 5, wherein the bun/burger ratio comprises a bun ratio of 55-70% of total combined weight of bun pieces and burger pieces of the bun/burger ratio and a burger ratio of 30-45% of total combined weight of bun pieces and burger pieces of the bun/burger ratio.

7. The pet food of claim 5, wherein the bun/burger ratio comprises a bun ratio of 65-70% of total combined weight of bun pieces and burger pieces of the bun/burger ratio and a burger ratio of 30-35% of total combined weight of bun pieces and burger pieces of the bun/burger ratio.

8. The pet food of claim 1, further comprising a cheese ratio of approximately 35% of total product weight and a bun/burger ratio of approximately 65% of total product weight.

9. The pet food of claim 8, wherein the bun/burger ratio comprises a bun ratio of approximately 67% of total combined weight of bun pieces and burger pieces of the bun/burger ratio and a burger ratio of approximately 33% of total combined weight of bun pieces and burger pieces of the bun/burger ratio.

10. A dry piece and soft moist piece cheeseburger dog food comprising:
a plurality of bun pieces, wherein the bun pieces are dry pet food shaped like hamburger buns;
a plurality of burger pieces, wherein the burger pieces are dry pet food shaped like hamburger patties; and
a plurality of cheese pieces, wherein the cheese pieces are soft moist pet food shaped like cheese slices, wherein the plurality of bun pieces and the plurality of burger pieces include a cheeseburger flavor and the plurality of cheese pieces are made with real cheese.

11. The dog food of claim 10, further comprising a cheese ratio of 30-35% of total product weight and a bun/burger ratio of 65-70% of total product weight.

12. The dog food of claim 11, wherein the bun/burger ratio comprises a bun ratio of 55-70% of total combined weight of bun pieces and burger pieces of the bun/burger ratio and a burger ratio of 30-45% of total combined weight of bun pieces and burger pieces of the bun/burger ratio.

13. The dog food of claim 11, wherein the bun/burger ratio comprises a bun ratio of 65-70% of total combined weight of bun pieces and burger pieces of the bun/burger ratio and a burger ratio of 30-35% of total combined weight of bun pieces and burger pieces of the bun/burger ratio.

14. The dog food of claim 10, further comprising a cheese ratio of 33-35% of total product weight and a bun/burger ratio of 65-67% of total product weight.

15. The dog food of claim 14, wherein the bun/burger ratio comprises a bun ratio of 55-70% of total combined weight of bun pieces and burger pieces of the bun/burger ratio and a burger ratio of 30-45% of total combined weight of bun pieces and burger pieces of the bun/burger ratio.

16. The dog food of claim 14, wherein the bun/burger ratio comprises a bun ratio of 65-70% of total combined weight of bun pieces and burger pieces of the bun/burger ratio and a burger ratio of 30-35% of total combined weight of bun pieces and burger pieces of the bun/burger ratio.

17. The dog food of claim 10, further comprising a cheese ratio of approximately 35% of total product weight and a bun/burger ratio of approximately 65% of total product weight.

18. The dog food of claim 17, wherein the bun/burger ratio comprises a bun ratio of approximately 67% of total combined weight of bun pieces and burger pieces of the bun/burger ratio and a burger ratio of approximately 33% of total combined weight of bun pieces and burger pieces of the bun/burger ratio.
